(19) United States
(12) Patent Application Publication
(10) Pub. No.: US 2008/0234424 A1
(43) Pub. Date: Sep. 25, 2008

(54) Carbon nanotube composite and method of preparing the same, carbon nanotube composite thin film prepared from the carbon nanotube composite and method of preparing the carbon nanotube composite thin film

(76) Inventors: Hang-Woo Lee, Yongin-si (KR); Yong-Wan Jin, Yongin-si (KR); Jong-Min Kim, Yongin-si (KR); Zhenan Bao, Stanford, CA (US)

Correspondence Address: ROBERT E. BUSHNELL, 1522 K STREET NW, SUITE 300, WASHINGTON, DC, 20005-1202, US

(21) Appl. No.: 11/889,309

(22) Filed: Aug. 10, 2007

Related U.S. Application Data
(60) Provisional application No. 60/859,508, filed on Nov. 17, 2006.

(30) Foreign Application Priority Data
Mar. 27, 2007 (KR) 10-2007-0030030

(51) Int. Cl. C08K 3/04; B82B 1/00

(52) U.S. Cl. 524/495; 977/750

(57) ABSTRACT

A carbon nanotube composite includes a carbon nanotube and a conjugated polymer. The carbon nanotube composite has a liquid crystalline property and a thin film prepared by rubbing-treating a solution of the carbon nanotube composite has a good alignment property and thus can be used in manufacturing carbon nanotube (CNT) thin film transistors (TFTs).

### CROSS-REFERENCE TO RELATED PATENT APPLICATION AND CLAIM OF PRIORITY

This application claims the benefit of U.S. Patent Application No. 60/859,508, filed on Nov. 17, 2006, in the U.S. Patent Office, and the benefit of Korean Patent Application No. 10-2007-0030030, filed on Mar. 27, 2007, in the Korean Intellectual Property Office the disclosure of which is incorporated herein in its entirety by reference.

### BACKGROUND OF THE INVENTION

1. Field of the Invention

The present invention relates to a carbon nanotube composite including a carbon nanotube having chirality and a conjugated polymer, a method of preparing the same, a carbon nanotube composite thin film prepared from the carbon nanotube composite and a method of preparing the same, and more particularly, to a carbon nanotube composite having a liquid crystalline property, a method of preparing the same, a thin anisotropic film prepared from the carbon nanotube composite, and a method of preparing the same.

2. Description of the Related Art

Carbon nanotubes have various anisotropic tube structures having a diameter of several to several tens of nanometers and a length of several tens to several hundreds of microns. Examples of these anisotropic tube structures include single-walled structures, multi-walled structures, and rope structures. Carbon nanotubes can have conducting or semiconducting properties depending on direction of winding, that is, chirality of the carbon nanotubes. Carbon nanotube powder includes semiconducting carbon nanotubes in zig-zag configurations and metallic carbon nanotubes in arm-chair configurations. Since semiconducting carbon nanotubes have various energy gaps depending on the diameter of the carbon nanotubes and a quasi one-dimensional structure, semiconducting carbon nanotubes have a unique proton effect, and thus research on a highly efficient nanotransistor using those properties of semiconducting carbon nanotubes has been actively carried out.

Further, carbon nanotubes have excellent mechanical strength (100 times stronger than steel), excellent chemical stability, high thermal conductivity, and an empty interior, and thus carbon nanotubes are widely used as a functional material for various microscopical and macroscopical applications. For example, research on using carbon nanotubes in memory devices, electron amplifiers or gas sensors, electromagnetic shielding devices, electrode plates of electrochemical storage devices such as secondary batteries, fuel cells, or super capacitors, field emission displays, polymer complexes, or the like has been actively conducted.

Generally, carbon nanotubes are prepared using chemical vapor deposition (CVD). Carbon nanotubes synthesized using CVD have various structures and are formed in a bundle structure due to the Van der Waals forces of the carbon nanotubes. Further, a carbon nanotube is an axis-symmetrical material, and thus has hydrophobicity due to its structural properties.

Since carbon nanotubes are not easily aligned due to properties thereof, functionalizing the carbon nanotubes and proper processes for the functionalization thereof are needed to improve alignment properties of the carbon nanotubes.

Low priced thin film transistors (TFTs) have been developed to increase market price competitiveness of large size LCDs, and an organic thin film transistor using a conjugated polymer has been actively developed. However, the organic materials that are used therein cannot be easily put to practical use due to low electrical mobility and limited processibility for large size applications. A material that is appropriately used in spin coating has been developed for large size processing using a conjugated polymer.

Carbon nanotubes can be used as materials for electrodes and TFT channel materials by aligning the carbon nanotubes using a self-assembly method using Langmuir-Blodgett thin film deposition, forming a complex with gelatin, or using an electric field in polyurethane. The self-assembly method includes chemical etching of the carbon nanotubes, and thus sidewalls of the carbon nanotubes may be structurally deformed, resulting in a deterioration of electrical and mechanical properties of the carbon nanotubes.

Since materials such as gelatin or polyurethane are not suitable for electronic devices, carbon nanotubes having such materials cannot be easily used in electronic devices.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a carbon nanotube composite in which a carbon nanotube has aligned thin film structure in large size applications, a method of preparing the same, a carbon nanotube composite thin film prepared from the carbon nanotube composite and a method of preparing the same.

According to an aspect of the present invention, there is provided a carbon nanotube composite including: a carbon nanotube; and a conjugated polymer which comprised of regioregular poly(3-alkylthiophene) represented by Formula 1 or a poly(methoxy-ethylhexyloxy-phenylene-vinylene) (MEH-PPV) represented by Formula 2.

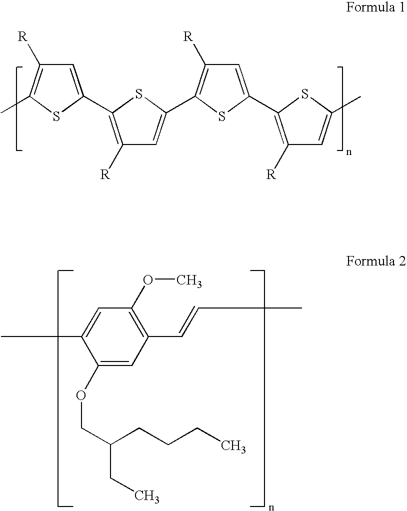

Here, n is an integer of 300 to 500, and each R is independently a linear or branched C6-C12 alkyl group.

According to another aspect of the present invention, there is provided a method of preparing a carbon nanotube composite, the method including:

mixing a carbon nanotube, a solvent, and a conjugated polymer which is poly(3-alkylthiophene) represented by Formula 1 or poly(methoxy-ethylhexyloxy-phenylene-vinylene) (MEH-PPV) represented by Formula 2; and

preparing a carbon nanotube composite dispersed in a solution by sonicating the mixture.

According to another aspect of the present invention, there is provided a method of preparing a carbon nanotube composite thin film, the method including:

mixing a carbon nanotube, a solvent, and a conjugated polymer which is comprised of poly(3-alkylthiophene) represented by Formula 1 or poly(methoxy-ethylhexyloxy-phenylene-vinylene) (MEH-PPV) represented by Formula 2;

preparing a carbon nanotube composite dispersed in a solution by sonicating the mixture; and

rubbing-treating the carbon nanotube composite dispersed in the solution on a substrate, thereby forming a carbon nanotube composite thin film.

According to another aspect of the present invention, there is provided a carbon nanotube composite thin film prepared according to the method of present invention.

The carbon nanotube composite of the present invention has liquid crystalline property, and a thin film prepared by rubbing treating a solution in which the carbon nanotube composite is dispersed has good alignment property and thus can be used in manufacturing carbon nanotube (CNT) thin film transistors (TFTs).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a method of preparing a carbon nanotube composite dispersed solution according to an embodiment of the present invention;

FIG. 2 shows cross-polarized light microscopic images of a carbon nanotube composite dispersed solution according to an embodiment of the present invention;

FIG. 3 illustrates a method of preparing a carbon nanotube composite thin film according to an embodiment of the present invention;

FIG. 4 shows cross-polarized light microscopic images of a carbon nanotube composite thin film according to an embodiment of the present invention; and

FIG. 5 is a graph showing a UV-Vis-NIR absorption spectrum according to polarization directions of thin films prepared according to an Example and Comparative Examples of the present invention.

### DETAILED DESCRIPTION OF THE INVENTION

Hereinafter, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

A carbon nanotube composite according to an embodiment of the present invention includes a carbon nanotube; and a conjugated polymer comprised of regioregular poly(3-alkylthiophene) represented by Formula 1 or poly(methoxy-ethylhexyloxy-phenylene-vinylene) (MEH-PPV) represented by Formula 2:

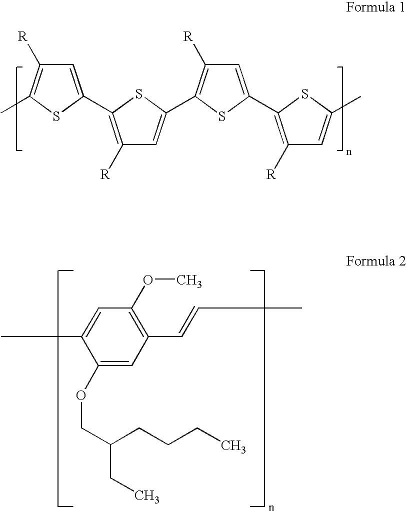

where n is an integer of 300 to 500, and each R is independently a linear or branched C6-C12 alkyl group. When the number of carbon atoms in the R is greater than 12, the composite may not be easily dispersed in a solvent. When the number of carbon atoms in the R is less than 6, the solubility of the polymer may be poor and the ability of forming coplanar structure in the backbone of the polymer may be poor, and thus the interaction between the carbon nanotube and the polymer may not be easy.

In one embodiment, R of Formula 1 may be a hexyl group.

The carbon nanotube may be a single-walled carbon nanotube (SWNT).

The carbon nanotube composite may be formed by a π-π interaction between the carbon nanotube and the conjugated polymer.

In the carbon nanotube composite, the weight ratio of the carbon nanotube to the conjugated polymer may be in the range of 1:0.5 to 1:3, and preferably 1:1. When the amount of the carbon nanotube is too small, that is, not within the range described above, the carbon nanotube composite may lose its liquid crystalline properties and the carbon nanotube may not be easily aligned. On the other hand, when the amount of the carbon nanotube is too large, that is, not within the range described above, the carbon nanotube may not be easily dispersed in the solvent.

The carbon nanotube composite according to an embodiment of the present invention may be prepared by mixing a carbon nanotube, a solvent, and a conjugated polymer which is comprised of poly(3-alkylthiophene) represented by Formula 1 or poly(methoxy-ethylhexyloxy-phenylene-vinylene) (MEH-PPV) represented by Formula 2; and preparing a carbon nanotube composite dispersed in a solution by sonicating the mixture.

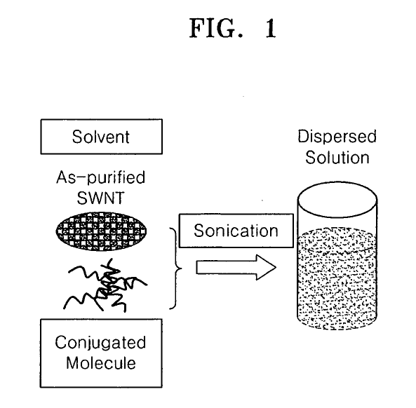

FIG. 1 illustrates a method of preparing a carbon nanotube composite dispersed in a solution according to an embodiment of the present invention.

The carbon nanotube used in a method of preparing the carbon nanotube composite according to an embodiment of the present invention may be a purified carbon nanotube or a crude carbon nanotube which is not purified. Known methods of synthesizing carbon nanotubes include are discharging, laser vaporization, high-pressure CO conversion (HiPCO), plasma chemical vapor deposition, and thermal chemical vapor deposition, but are not limited thereto.

When a crude carbon nanotube is used in the method of preparing the carbon nanotube composite according to an embodiment of the present invention, the method may further include purifying the crude carbon nanotube before mixing the carbon nanotube, the solvent and the conjugated polymer since amorphous carbon agglomeration or catalyst metal agglomeration need to be removed through the purification to obtain properties of the carbon nanotube.

The crude carbon nanotube can be purified by any method that is commonly used in the art, such as vapor phase thermal purification, acid purification, or surfactant purification. In acid purification, nitric acid solution or hydrochloric acid solution may be used as an acid solution, and the crude carbon nanotube may be immersed in a purification bath having the nitric acid solution or hydrochloric acid solution for 1 to 4 hours. Here, H+ in the acid solution removes carbon agglomeration or carbon particles, and Cl⁻ or NO₃⁻ removes catalyst metal agglomeration. Then, the crude carbon nanotube may be washed by supplying ultra pure water into the purification bath including the mixed solution in which the carbon nanotube is dispersed and allowing the acid solution to overflow from the purification bath, and filtering the washed resultant to collect carbon agglomeration, carbon particles, and catalyst metal agglomeration using a metallic mesh filter having a size of 300 μm or less to obtain purified carbon nanotubes.

In vapor phase thermal purification, the crude carbon nanotube is placed in a boat in the center of a reaction furnace, and heated. When an acidic purifying gas such as hydrochloric acid gas or nitric acid gas is flowed into the reaction furnace and heated, impurities such as carbon agglomeration are removed by hydrogen ions which are created by thermal decomposition of the acidic purifying gas, and catalyst metal agglomeration is removed by Cl⁻ or NO₃⁻ which is also created by the thermal decomposition of the acidic purifying gas.

Alternatively, the carbon nanotube may be mixed with a surfactant such as SDS, and centrifuged the mixture and obtained an upper layer. Then, the upper layer may be added to acetone to form precipitates, and the mixture may be filtered to purify the carbon nanotube.

The solvent may be dichlorobenzene, tetrahydrofuran (THF) or chloroform (CHCl₃), and preferably dichlorobenzene.

In the method of preparing the carbon nanotube composite dispersed solution according to the current embodiment of the present invention, the weight ratio of the carbon nanotube to the conjugated polymer may be in the range of 1:0.5 to 1:3, and preferably 1:1.

The sonication in preparing the carbon nanotube composite dispersed in the solution may be performed for 20 to 60 minutes.

The concentration of the carbon nanotube may be in the range of 1.5 to 2.8 mg, and preferably 2 mg, per ml of the solvent.

The carbon nanotube composite dispersed in the solution may have a liquid crystalline property within specific ranges of weight ratio and concentration of the carbon nanotube.

A carbon nanotube composite thin film may be prepared by rubbing-treating the obtained carbon nanotube composite dispersed solution on a substrate. The rubbing treatment may be performed by rubbing the carbon nanotube composite dispersed solution with a glass rod to uniformly spread the solution in which the carbon nanotube composite is dispersed on the substrate.

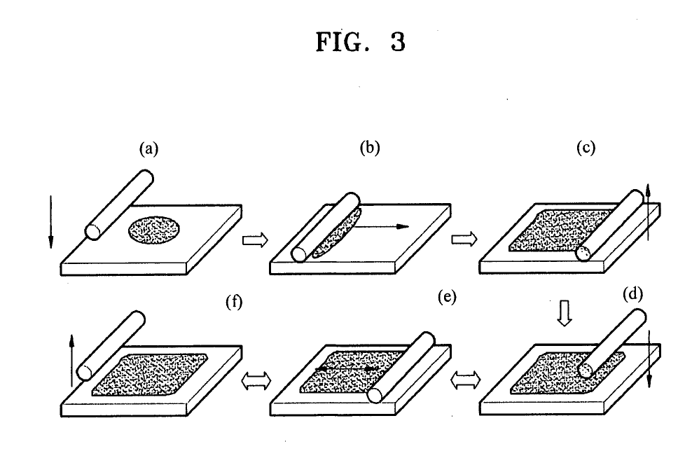

FIG. 3 illustrates a method of preparing the carbon nanotube composite thin film according to an embodiment of the present invention. Referring to FIG. 3, a carbon nanotube composite dispersed solution is applied to a substrate as shown in (a) of FIG. 3, the solution is rubbed by rolling a rod in one direction to spread the solution across the whole surface of the substrate as shown in (b) and (c) of FIG. 3, the rode is detached from the substrate as shown in (c) of FIG. 3, then the rod is rolled in both directions to form a carbon nanotube composite thin film as shown in (c) and (d) of FIG. 3, and the rod is removed as shown in (f) of FIG. 3.

A carbon nanotube composite thin film having the carbon nanotube aligned in the rubbing direction and a conjugated polymer can be prepared by rubbing the carbon nanotube composite dispersed solution on the substrate.

The carbon nanotube composite thin film prepared using the method described above can have uniform anisotropy in a wide range, and thus can be applied to a thin film transistor of a large size LCD having excellent property.

Hereinafter, the present invention will be described more specifically with reference to the following examples. The following examples are for illustrative purposes and thus are not intended to limit the scope of the invention.

### SYNTHESIS EXAMPLE 1

### Synthesis of Purified Single-Walled Carbon Nanotubes (SWNT)

### Solubilization of SWNT using a surfactant (SDS)

80 mg of SWNT (HiPCo), 2 g of sodium dodecyl sulfate (SDS, J. T. Baker), and 200 ml of ultra pure water (0.1 micro-filtered, Invitrogen Co.) were mixed in a 400 m beaker. The beaker was cooled in an ice bath while sonicating for 30 minutes using a Cole-Parmer Ultrasonic Processor (750 W). The beaker was centrifuged at 4° C. for 4 hours using a Sorvall PR5C Plus (12,500 rpm). Then, a supernatant was decanted with caution to obtain a homogenous dark black solution (SWNT+SDS).

Removing SDS and Collecting SWNT

15 ml of acetone was added to 5 ml of the mixed solution having SWNT and SDS prepared in Synthesis Example 1, and the mixture was vigorously stirred for a few seconds to obtain a large amount of black precipitates.

The mixture was centrifuged for 20 minutes using a Sorvall RC5C Plus at 12,500 rpm, and the supernatant was removed.

The precipitates were washed three times with acetone using centrifugation for 10 minutes each, and the supernatant was removed to obtain a pure SWNT in which the surfactant was removed.

The resultant was filtered using a PTFE film (Millipore, 0.45 μm) to collect a carbon nanotube. A bucky paper was obtained on the film. The bucky paper was carefully peeled off the film. The peeled-off bucky paper was placed in a vacuum oven, and dried at 50° C. overnight. Thus, a dried and purified SWNT was obtained.

### EXAMPLE 1

3 mg of the carbon nanotube purified in Synthesis Example 1 was mixed with 3 mg of a poly(3-hexylthiophene) represented by Formula 1 wherein R is hexyl and 1.5 ml of dichlorobenzene, and the mixture was sonicated using a Parmer Ultrasonic Processor (750 W) for 30 minutes to prepare a carbon nanotube composite dispersed solution.

The carbon nanotube composite dispersed solution was spread between two slide glasses and observed using a cross polarized light microscope (Nikon, Model No.: Optiphot2-Pol with crossed polarizers).

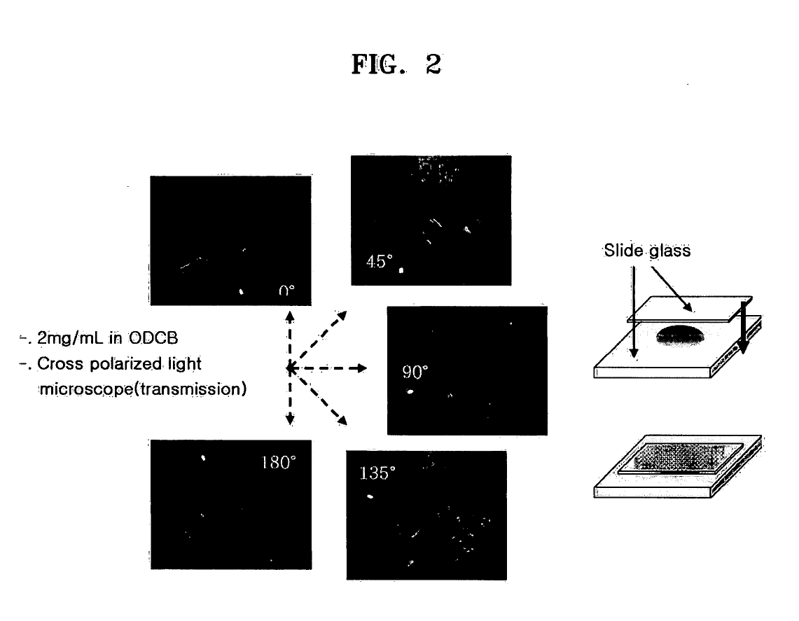

FIG. 2 shows cross-polarized light microscopic images of the carbon nanotube composite dispersed solution produced in Example 1. As shown in FIG. 2, it was identified that a liquid crystal phase was formed in the carbon nanotube composite dispersed solution produced in Example 1.

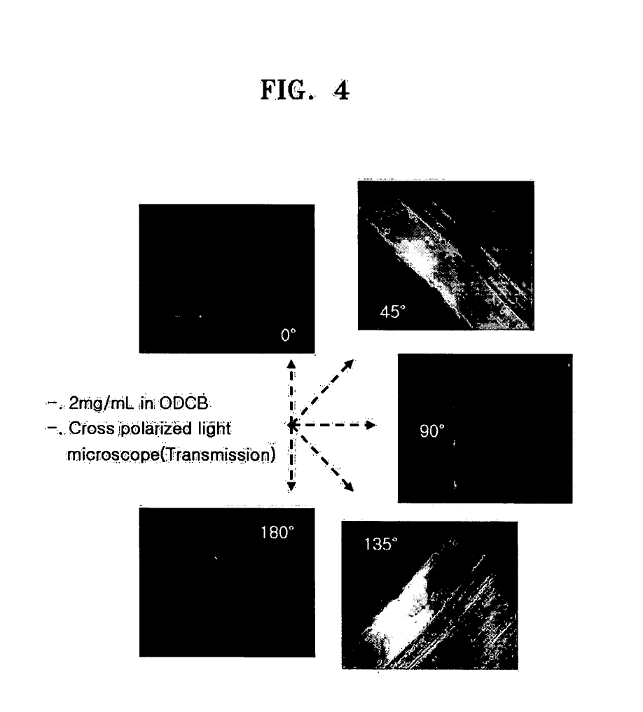

A carbon nanotube composite thin film was prepared by rubbing the carbon nanotube composite dispersed solution produced in Example 1 on a glass substrate as illustrated in FIG. 3. FIG. 4 shows cross-polarized light microscopic images of the carbon nanotube composite thin film thus formed, and it was identified that the carbon nanotube composite was aligned in the rubbing direction.

### COMPARATIVE EXAMPLE 1

A thin film was prepared in the same manner as in Example 1, except that a solution in which 3 mg of SWNT purified in Synthesis Example 1 was dispersed in 1.5 ml of dichlorobenzene was used, thereby forming a carbon nanotube thin film.

### COMPARATIVE EXAMPLE 2

A thin film was prepared in the same manner as in Example 1, except that a solution in which 3 mg of poly(3-hexylthiophene) represented by Formula 1 wherein R is hexyl was dispersed in 1.5 ml of dichlorobenzene was used, thereby forming a polymer thin film.

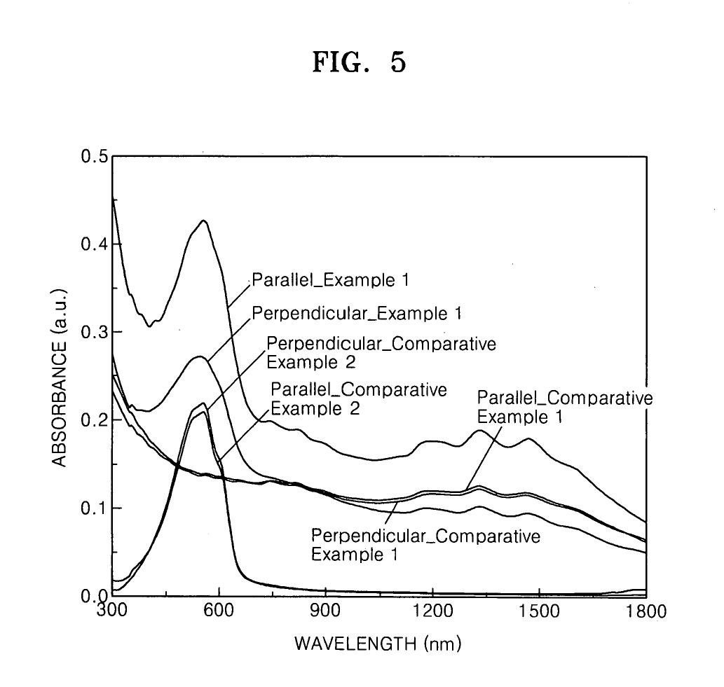

FIG. 5 is a graph showing a UV-Vis-NIR absorption spectrum according to polarization directions of thin films prepared according to the Example and Comparative Examples 1 and 2 of the present invention. Referring to FIG. 5, while anisotropy was not observed in the carbon nanotube thin film of Comparative Example 1 and the polymer thin film of Comparative Example 2, anisotropy was observed in the carbon nanotube composite thin film of the embodiment of the present invention (Example 1).

According to the embodiments of the present invention, a carbon nanotube composite including a carbon nanotube and a conjugated polymer has a liquid crystalline property within specific ranges of weight ratio and concentration of the carbon nanotube, and a thin film prepared by rubbing-treating a dispersed solution of the carbon nanotube composite has a good alignment property and thus can be used in manufacturing carbon nanotube (CNT) thin film transistors (TFTs).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A carbon nanotube composite comprising:
a carbon nanotube; and
a conjugated polymer comprising regioregular poly(3-alkylthiophene) represented by Formula 1 or a poly(methoxy-ethylhexyloxy-phenylene-vinylene) (MEH-PPV) represented by Formula 2: 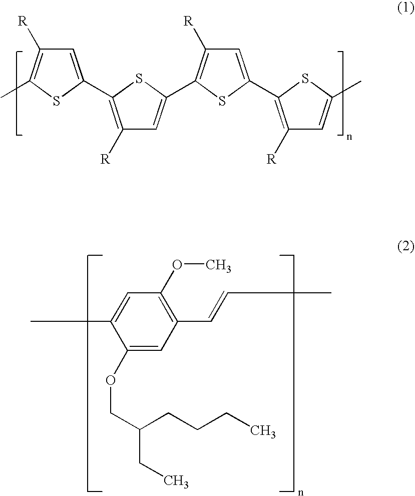
where n is an integer of 300 to 500, and each R is independently a linear or branched C6-C12 alkyl group.

2. The carbon nanotube composite of claim 1, wherein the conjugated polymer comprises the regioregular poly(3-alkylthiophene) represented by Formula 1.

3. The carbon nanotube composite of claim 1, wherein the conjugated polymer comprises the poly(methoxy-ethylhexyloxy-phenylene-vinylene) (MEH-PPV) represented by Formula 2.

4. The carbon nanotube composite of claim 1, wherein the weight ratio of the carbon nanotube to the conjugated polymer is in the range of 1:0.5 to 1:3.

5. The carbon nanotube composite of claim 4, wherein the weight ratio of the carbon nanotube to the conjugated polymer is 1:1.

6. The carbon nanotube composite of claim 1, wherein the carbon nanotube is a single-walled carbon nanotube.

7. A carbon nanotube composite thin film produced by rubbing-treating the carbon nanotube composite of claim 1.

8. A method of preparing a carbon nanotube composite, the method comprising:
mixing a carbon nanotube, a solvent, and a conjugated polymer which is poly(3-alkylthiophene) represented by Formula 1 or poly(methoxy-ethylhexyloxy-phenylene-vinylene) (MEH-PPV) represented by Formula 2; and
preparing a carbon nanotube composite dispersed in a solution by sonicating the mixture: 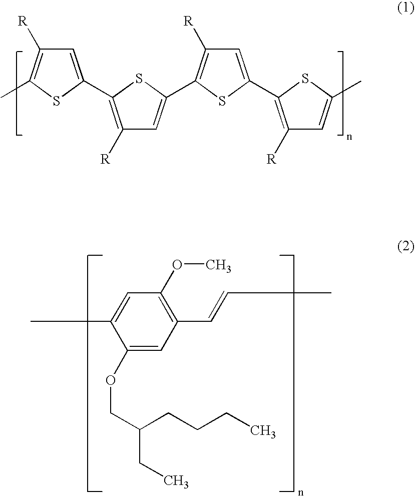
where n is an integer of 300 to 500, and each R is independently a linear or branched C6-C12 alkyl group.

9. The method of claim 1, wherein the conjugated polymer comprises the regioregular poly(3-alkylthiophene) represented by Formula 1.

10. The method of claim 1, wherein the conjugated polymer comprises the poly(methoxy-ethylhexyloxy-phenylene-vinylene) (MEH-PPV) represented by Formula 2.

11. The method of claim 8, wherein the weight ratio of the carbon nanotube to the conjugated polymer is in the range of 1:0.5 to 1:3.

12. The method of claim 8, wherein the solvent is selected from the group consisting of dichlorobenzene, tetrahydrofuran, and chloroform.

13. The method of claim 8, wherein the concentration of the carbon nanotube dispersed in the solution is in the range of 1.5 to 2.8 mg per ml of the solvent.

14. The method of claim 8, wherein the sonication is performed for 20 to 60 minutes.

15. The method of claim 8, wherein the carbon nanotube is a single-walled carbon nanotube.

16. A method of preparing a carbon nanotube composite thin film, the method comprising:
mixing a carbon nanotube, a solvent, and a conjugated polymer which is comprised of poly(3-alkylthiophene) represented by Formula 1 or poly(methoxy-ethylhexyloxy-phenylene-vinylene) (MEH-PPV) represented by Formula 2;
preparing a carbon nanotube composite dispersed in a solution by sonicating the mixture; and
rubbing-treating the carbon nanotube composite dispersed in the solution on a substrate, thereby forming a carbon nanotube composite thin film: 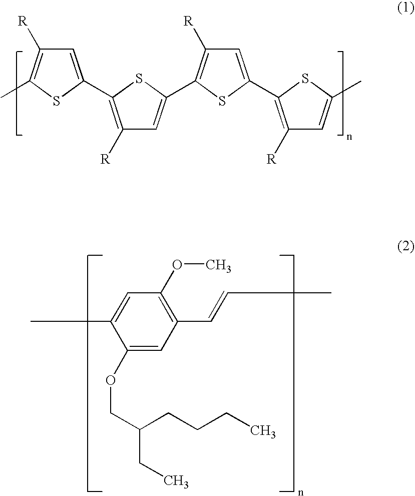
where n is an integer of 300 to 500, and each R is independently a linear or branched C6-C12 alkyl group.

17. The method of claim 16, wherein the conjugated polymer comprises the regioregular poly(3-alkylthiophene) represented by Formula 1.

18. The method of claim 16, wherein the conjugated polymer comprises the poly(methoxy-ethylhexyloxy-phenylene-vinylene) (MEH-PPV) represented by Formula 2.

19. The method of claim 16, wherein the weight ratio of the carbon nanotube to the conjugated polymer is in the range of 1:0.5 to 1:3;
the solvent is selected from the group consisting of dichlorobenzene, tetrahydrofuran, and chloroform; and
the concentration of the carbon nanotube dispersed in the solution is in the range of 1.5 to 2.8 mg per ml of the solvent.

20. A carbon nanotube composite thin film prepared according to the method of claim 16.
